(19) United States
(12) Patent Application Publication
(10) Pub. No.: US 2010/0205804 A1
(43) Pub. Date: Aug. 19, 2010

(54) Thick Conductor

(76) Inventor: Alireza Ousati Ashtiani, Tehran (IR)

Correspondence Address: PATWRITE LLC, 408 W. MAIN ST., MARSHALLTOWN, IA, 50158-5759, US

(21) Appl. No.: 12/650,729

(22) Filed: Dec. 31, 2009

Related U.S. Application Data
(60) Provisional application No. 61/153,037, filed on Feb. 17, 2009.

(51) Int. Cl. H01R 43/16

(52) U.S. Cl. 29/885

(57) ABSTRACT

A method of manufacturing a plurality of thick conducting lines for display devices by means of plating method whereby low resistivity for fabricated conductors and at the same time low manufacturing cost are realized. Plating method can be electroplating, electroless plating or combination of both. Substrate in displays can be flat or can have predefined grooves therein. Over this substrate, a thick layer of conductor is applied by means of plating method. The instant invention can reduce row resistance to more than one fourth of original value and in the same time reduce total cost of completed panel.

### CROSS REFERENCE TO RELATED APPLICATIONS

This application claims priority and herein incorporates by reference U.S. provisional patent application 6,115,3037, filed Feb. 17, 2009.

### BACKGROUND OF THE INVENTION

In many types of flat panel and flexible displays, there is an increasing demand to fabricate conducting lines that have the least possible electrical resistance. For instance, in passive matrix electroluminescence displays, surface conduction emission displays, ballistic electron surface emitting displays, AMOLED and PMOLED displays, it would be suitable to decrease resistance of conducting lines in order to enhance performance of device. Specifically in the case of large area ELD, OLED and even more in SED and BSD, this resistance can really become problematic and expensive methods of creating thick film conductors are currently used. For example, in SED manufacturing, thick silver conductive inks are used that are very expensive.

One more problem that arises in the case of SED is the fact that due to relatively high current that passes through row lines, one should add two sets of expensive electronic drivers, one at each end of row conductor. If we somehow manage to reduce row lines resistivity substantially, we can use just one set of row driver at only one end of row conductors, resulting in 50% row driver cost reduction that can be a HUGE saving for SED manufacturers.

In addition to cost saving related to reducing numbers of driving circuits, one can understand that replacing expensive silver conductive ink in SED manufacturing with lower cost materials like aluminum and copper can also lead to even more cost saving.

Also it is worth noting that using row lines with substantially reduced resistance in high current displays like SED and BSD can result in reduced voltage variation among different points of an active row line. This improved voltage homogeneity will dramatically mitigate cross talk between different pixels, resulting in a more robust and predictable display.

In today's display manufacturing plants, very expensive methods that are mostly done in vacuum chambers by either physical or chemical deposition techniques are used to deposit metal layers and these methods are not capable of producing thick layers fast enough with reasonable cost. In addition to vacuum based production lines, leaner manufacturing methods like direct printing are being proposed that still rely on expensive conductive inks and also they are not cheap enough to produce thick layers of conductors. So neither vacuum based manufacturing methods nor printing method are capable enough to produce low cost thick conducting lines.

To summarize, one can see the need of finding a simple and low cost fabrication method to produce a plurality of thick film conductors in many display types that can benefit from low resistivity, low cost row lines.

### SUMMARY OF THE INVENTION

A method of manufacturing a plurality of thick conducting lines for display devices by means of plating method whereby low resistivity for fabricated conductors and at the same time low manufacturing cost are realized. Plating method can be electroplating, electroless plating or combination of both. Substrate in displays can be flat or can have predefined grooves therein. Over this substrate, a thick layer of conductor is applied by means of plating method. The instant invention can reduce row resistance to more than one fourth of original value and in the same time reduce total cost of completed panel.

Other features and advantages of the instant invention will become apparent from the following description of the invention which refers to the accompanying drawings.

### BRIEF DESCRIPTION OF THE DRAWINGS

FIG. 1A shows a cross section of a substrate according to a manufacturing step in the fabrication of a thick conductor according to an embodiment of the invention.

FIG. 1B shows a cross section of a substrate according to another manufacturing step in the fabrication of a thick conductor according to an embodiment of the invention.

FIG. 1C shows a cross section of a substrate according to another manufacturing step in the fabrication of a thick conductor according to an embodiment of the invention.

FIG. 1D shows a cross section of a substrate according to another manufacturing step in the fabrication of a thick conductor according to an embodiment of the invention.

FIG. 1E shows a cross section of a substrate according to another manufacturing step in the fabrication of a thick conductor according to an embodiment of the invention.

FIG. 2A shows a cross section of a substrate according to another manufacturing step in the fabrication of a thick conductor according to an embodiment of the invention.

FIG. 2B shows a cross section of a substrate according to another manufacturing step in the fabrication of a thick conductor according to an embodiment of the invention.

FIG. 2C shows a cross section of a substrate according to another manufacturing step in the fabrication of a thick conductor according to an embodiment of the invention.

FIG. 2D shows a cross section of a substrate according to another manufacturing step in the fabrication of a thick conductor according to an embodiment of the invention.

FIG. 2E shows a cross section of a substrate according to another manufacturing step in the fabrication of a thick conductor according to an embodiment of the invention.

FIG. 3A shows a cross section of a substrate according to another manufacturing step in the fabrication of a thick conductor according to an embodiment of the invention.

FIG. 3B shows a cross section of a substrate according to another manufacturing step in the fabrication of a thick conductor according to an embodiment of the invention.

FIG. 3C shows a cross section of a substrate according to another manufacturing step in the fabrication of a thick conductor according to an embodiment of the invention.

FIG. 3D shows a cross section of a substrate according to another manufacturing step in the fabrication of a thick conductor according to an embodiment of the invention.

FIG. 3E shows a cross section of a substrate according to another manufacturing step in the fabrication of a thick conductor according to an embodiment of the invention.

FIG. 3F shows a cross section of a substrate according to another manufacturing step in the fabrication of a thick conductor according to an embodiment of the invention.

FIG. 4A shows a cross section of a substrate according to another manufacturing step in the fabrication of a thick conductor according to an embodiment of the invention.

FIG. 4B shows a cross section of a substrate according to another manufacturing step in the fabrication of a thick conductor according to an embodiment of the invention.

FIG. 4C shows a cross section of a substrate according to another manufacturing step in the fabrication of a thick conductor according to an embodiment of the invention.

FIG. 4D shows a cross section of a substrate according to another manufacturing step in the fabrication of a thick conductor according to an embodiment of the invention.

FIG. 5 shows a schematic diagram of an electrodeposition bath used in the manufacturing process.

FIG. 6A is a circuit diagram of a prior art surface conduction electron emitter display.

FIG. 6B is a circuit diagram of a surface conduction electron emitter display according to an embodiment of the invention.

### DETAILED DESCRIPTION OF THE INVENTION

In the following detailed description of the invention, reference is made to the drawings in which reference numerals refer to like elements, and which are intended to show by way of illustration specific embodiments in which the invention may be practiced. It is understood that other embodiments may be utilized and that structural changes may be made without departing from the scope and spirit of the invention.

In this invention, various methods that are based on electroless plating or electroplating (or simply called plating) is used to create a plurality of thick conducting lines.

Before going into details about different embodiments of this invention, the main points of this invention will be described in order to give an overall understanding. Then, different embodiments of this invention will be described based on those main points so one will understand them comprehensively.

First point: Creating thin conducting film:

In a couple of embodiments of this invention, it is necessary to fabricate a thin conducting film. In order to fabricate a thin conducting film, we can use direct printing of conductive ink, vacuum deposition or electroless deposition, the latter having the least cost. In the case of electroless deposition, one needs to follow these steps:

Providing seeds to grow thin conducting film over substrate:

In order to coat the substrate with a thin conducting film, electroless deposition methods are available for many metals; however, electroless plating techniques will perform better over some catalytic seeds (this process is sometimes called “substrate activation”). We might need to add metallic nanoparticle first. Silver electroless plating is an example that can be used to provide these nanoparticle seeds. As an alternative to silver nanoparticle coating, activation by palladium salt can be used to replace “nanosilver seeds”, resulting in activated substrate surface that can be later coated by electroless deposited nickel, copper or other metals.

Deposition of thin conducting film:

This coating can be deposited over activated substrate by electroless deposition. Nickel and silver electroless plating are two appropriate choices that are well known, reliable and cheap. However, other metals might be considered, too. This electroless deposition can be continued in order to provide thick film. However, electrodeposition is more flexible, faster and less expensive.

Second point: thick metal film deposition:

After applying thin conducting film, we can use electroplating to add a thick coat over this thin conducting layer to fabricate the device. For example, Metals like copper and nickel can be electroplated in aqueous solutions. In addition, more reactive metals like aluminum can also be deposited inside non-aqueous solutions like molten salts. (Other methods like SIGAL (aluminizing) is also available to deposit a thick, pore free and uniform coating of aluminum.)

As an alternative to electrodeposition, electroless plating can be used to directly coat catalyst seeds with a thick metallic layer. This metallic layer can later act as catalyst again to promote growth of a different metallic layer or we can continue this first growth reaction to deposit a thick conductor. A simple approach to thick film electroless deposition would be to provide initial growing sites over substrate and leave it inside electroless deposition bath to gradually plate it with a thick film. Thick metal film made of copper can be easily deposited by this method.

Third point: Note about homogeneity and uniformity of thick metal film in electrodeposition:

If we opt for electrodeposition method to create main thick conducting lines (or plate) in ordinary electroplating bath, it is likely that a non-uniform layer will be deposited that is thicker at the ends of cathode electrode that are closer to power supply. In other words, final deposited film will be thick at the ends and will gradually become thinner in the center of the plate (in case we connect both ends of thin film plates or lines to power supply) or at the other end that is not connected to power supply. Although we can later flatten this layer by methods like chemical mechanical polishing, it desirable to find a technique to prevent this nonuniformity at first. A couple of methods are described in prior art, but here a simple method will be described.

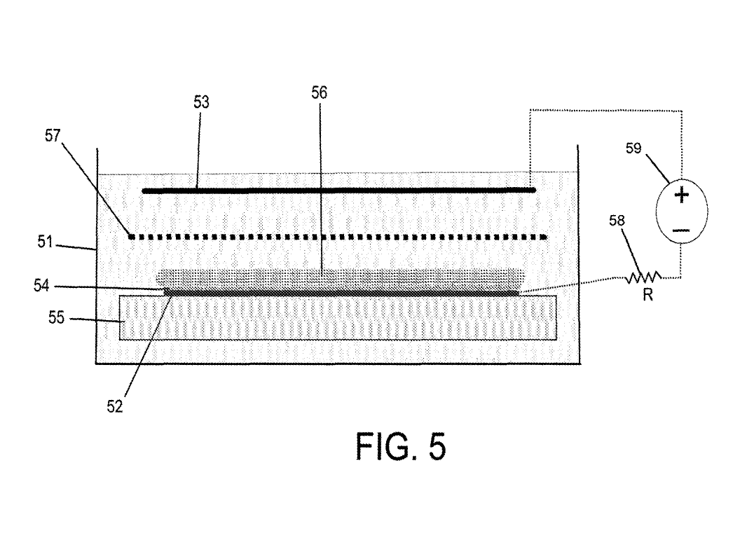

In order to accomplish this, we add a second layer that has poor conductivity (high resistivity) over thin conducting film. With reference to FIG. 5, an electrodeposition bath is shown as 51 and having a thin film cathode 52, an anode 53 (anode 53 can be either a consumable or permanent anode), a substrate 55, a resistive layer 54, a fabricated thick conductor 56 and an optional mechanical barrier 57.

If we opt for adding resistive layer 54 over thin cathode 52, thick electrodeposited film 56 will settle down over this high resistivity layer. During the deposition procedure (because of presence of high resistivity layer), potential difference between various parts of the primary cathode plate will be minimized because most of the voltage drop will occur inside this resistive layer and not over the length of thin film of thin conducting film. As a result, a homogenous electrical current density will flow from almost all parts of thin conducting film; therefore, a homogeneous film will be deposited over this resistive layer. Supplementary methods like addition of physical barrier 57 inside the bath between anode 53 and cathode 52 to prevent excessive metallic ions from reaching lower resistivity sites will add extra uniformity.

In addition, it is a good idea to add a series resistor (shown as 58 in FIG. 5) between a power supply unit 59 and thin conducting film 52 in order to further increase homogeneity of voltage over entire surface of thin conducting film. (Addition of this series resistor will result in even more uniform growth of thick conductor over entire thin conducting film because of more uniform electrical potential over entire thin conducting film of cathode.)

Fourth point: Method of manufacturing a plurality of thick conductors:

There are numerous methods to create plural lines of thick conductors that can be used for displays. Based on this invention, we can opt for additive or subtractive manufacturing methods. In other words, from a general point of view, we can either create plural lines in situ or create a continuous coat and later define plural lines by patterning and etching so we have two options:

1. Deposit a continuous film and etch it later to fabricate a plurality of separated conducting lines.

2. Selectively grow thick conducting lines over predefined patterns by using the methods described in this invention. (For example, growing thick film by electrodeposition over predefined patterns of printed conductive ink or selective electroless growth of thick conductor over those activated areas of substrate.) This has the advantage that no etching is required to fabricate plural conducting lines and these separated lines are created in situ.

Fifth point: Note about substrate:

Substrate can be either planar or with predefined grooves. Working with a planar plate is less expensive (because creating grooves inside substrate will need additional manufacturing steps like mask patterning and etching) but applying thick conductors over a planar surface will make final metalized substrate a little bumpy; so a substrate with grooves inside it can be used instead to enable us to partially or completely bury thick conductors inside these grooves. In order to create a substrate with a plurality of grooves therein, one can opt for methods like chemical etching or sandblasting.

In this configuration (a substrate with predefined grooves therein), first a plurality of grooves are created in a substrate; then thick conductors will be placed completely or partially inside these grooves. Burying thick conductors inside predefined grooves has the additional advantage that it makes metal layers more robust and better bonded to substrate, preventing exfoliation, delaminating or detachment from substrate.

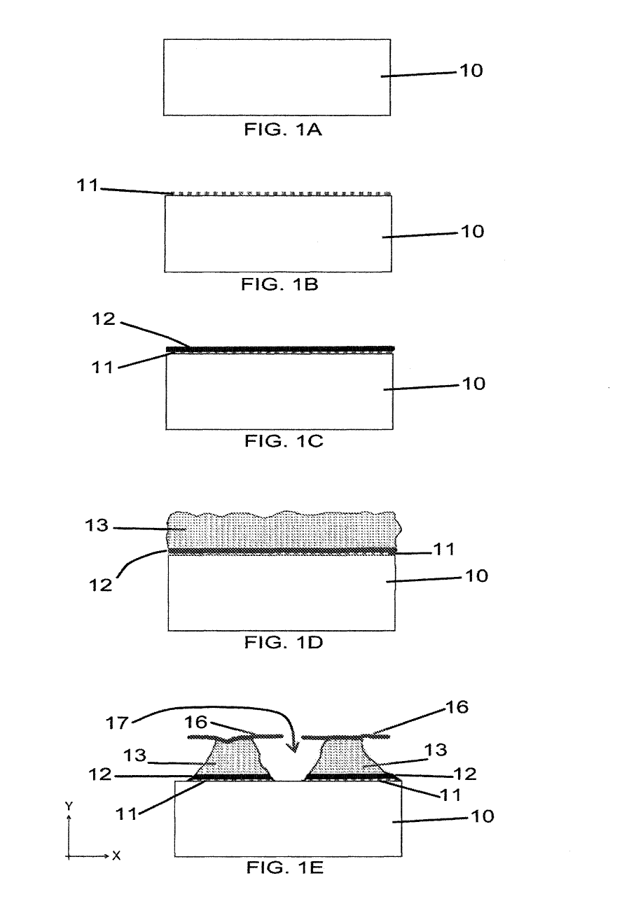

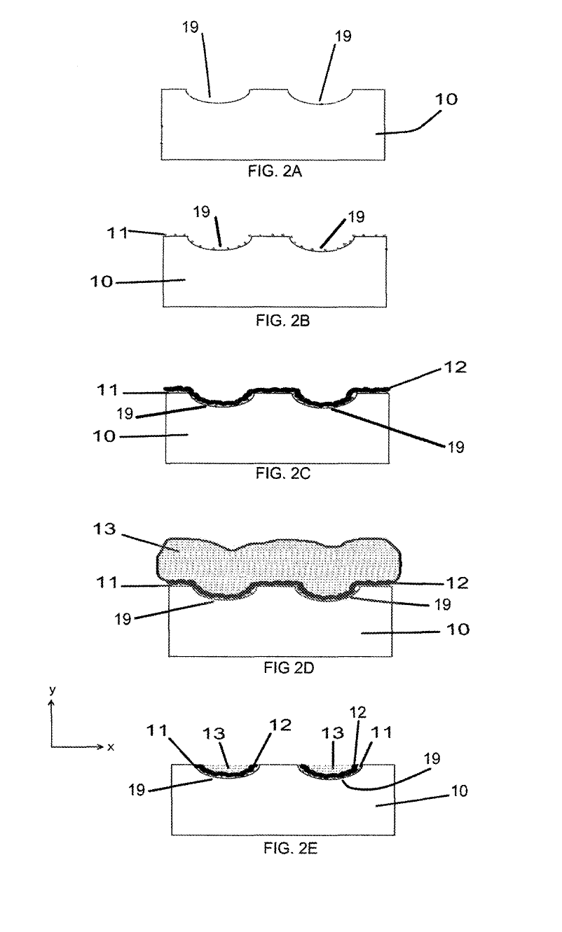

In one manufacturing method for example, we can use direct conductive ink printing to define a plurality of thin conducting lines inside the grooves, then we can coat it with a thick conductor (by either electroplating or electroless plating method) and finally, residuals can be wiped out by CMP (chemical mechanical planarization) to leave thick conductors buried inside the grooves and result in a planar surface. In order to compare a planar substrate with a substrate with predefined grooves therein, one can compare FIG. 1E and FIG. 2E. In FIG. 1E, a planar substrate is used. As can be seen, final product has bumpy thick conducting lines over flat substrate. Contrary to that, in FIG. 2E, we can see that in the case of a substrate with predefined cavities one can planarize the substrate in the final steps of manufacturing and still have a thick conductor fully buried inside the cavities

Sixth point: note about copper diffusion:

Copper diffusion in silicon in known to alter its characteristic and should usually be avoided. Also in FED, copper will alter cathodoluminescence properties of phosphors; therefore, we might be forced to use a diffusion barrier in the case of copper coating. In order to do so, a simple method is to use a relatively thin (a micrometer or so) layer of nickel or other suitable material like other metals, metal nitrides or carbides to encapsulate copper. For example, we can coat these copper conductors with nickel coating by electroplating (or electroless plating). By doing so, entire copper will be encapsulated inside a protecting film that will provide adequate barrier to copper diffusion.

### ALTERNATIVE EMBODIMENTS OF THE INVENTION

After a description of main points of this invention, a couple of embodiments of this invention are described here:

### Embodiment A

Referring to FIG. 1A to 1E, subtractive method over flat surface is shown having the following steps:

A substrate 10 is coated with catalytic seeds like silver nanoparticle 11 by electroless deposition method or activated by salts like palladium salt. Over this activated surface, electroless deposition method is used to coat our thin conducting film, for instance nickel plate 12. This will result in a continuous thin conducting film. An optional resistive layer (not shown) may be added over this thin conducting coat to increase homogeneity of to-be-deposited thick conductor as discussed before. Over this thin conducting film, metals like copper, nickel or aluminum can be electroplated as can be seen as 13. Finally, we can add a pattered mask 16 to etch cavities 17 and separate metal lines to fabricate plural lines of conductor.

### Embodiment AA

This embodiment is similar to embodiment A but electroless deposition is used to create thick metal film which in some cases might have lower cost.

### Embodiment B

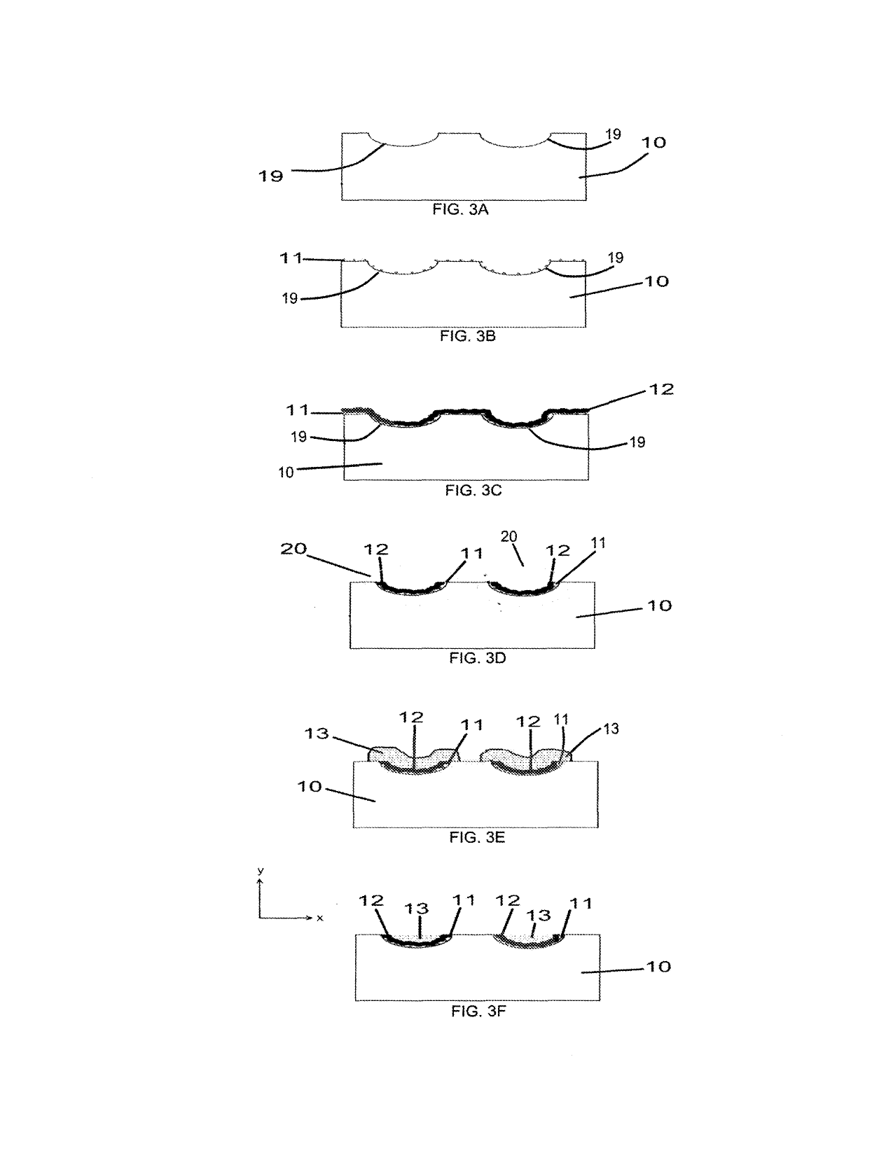

Referring now to FIGS. 2A to 2E and 3A to 3F, subtractive method with predefined grooves are shown having a substrate 10 which is first patterned and etched (or sand blasted) to provide plural grooves 19. Then this etched substrate is coated with activating agents 11 like silver nanoparticles by electroless deposition method or activated by salts like palladium salt. Over these activated seeds, electroless deposited metal 12 (like nickel plate) is added to provide a continuous thin conducting film. Again, an optional resistive layer (not shown) might be added over this thin conducting film to increase homogeneity as discussed before. After that, we can either:

Coat entire thin conducting film surface with electroplated metal 13 and later define separated lines by CMP. (As can be seen in FIG. 2D and FIG. 2E) or use CMP over this relatively thin conducting film to wipe unnecessary portions of coating (shown as 3D) and later coat the remaining inside the grooves, shown as 20 in FIG. 3E, with electroplated material 13. Finally (if necessary), to flatten these thick conducting lines, we can use planarization methods like CMP once more to provide smooth and flat conducting lines. (As can be seen in FIG. 3F)

### Embodiment BB

similar to embodiment B but instead of electrodeposition, electroless deposition is used to create thick metal film.

### Embodiment C

use of direct printing of a plurality of thin conducting lines: as mentioned earlier, with the advent of additive manufacturing based on industrial ink jet printers, we can neglect the step of “providing seeds to grow thin conducting film” and directly print a plurality of thin conducting lines. There are many different types of inks that can be used to provide adequate conductivity as is known in the art.

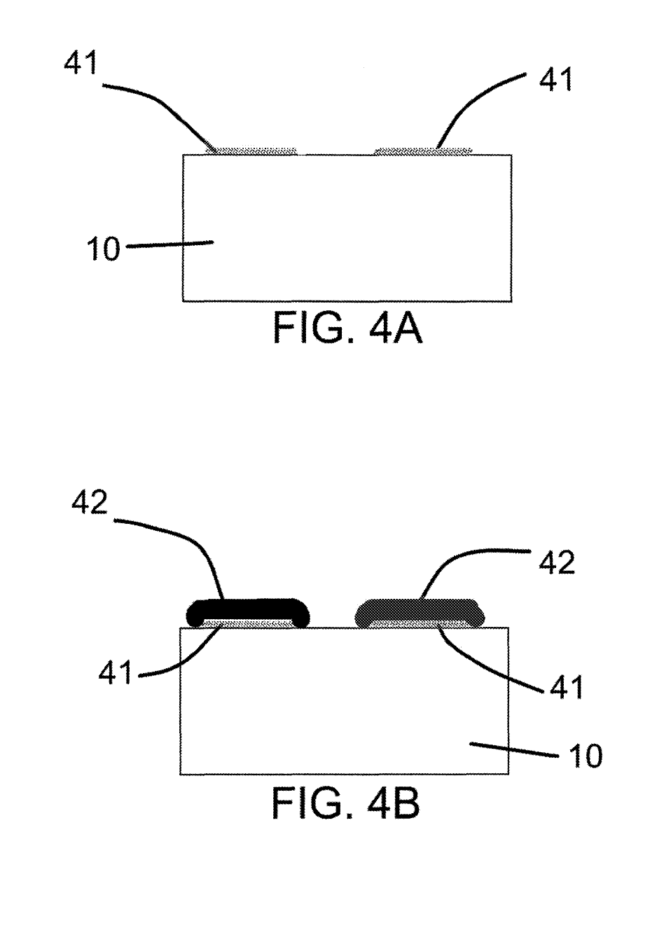

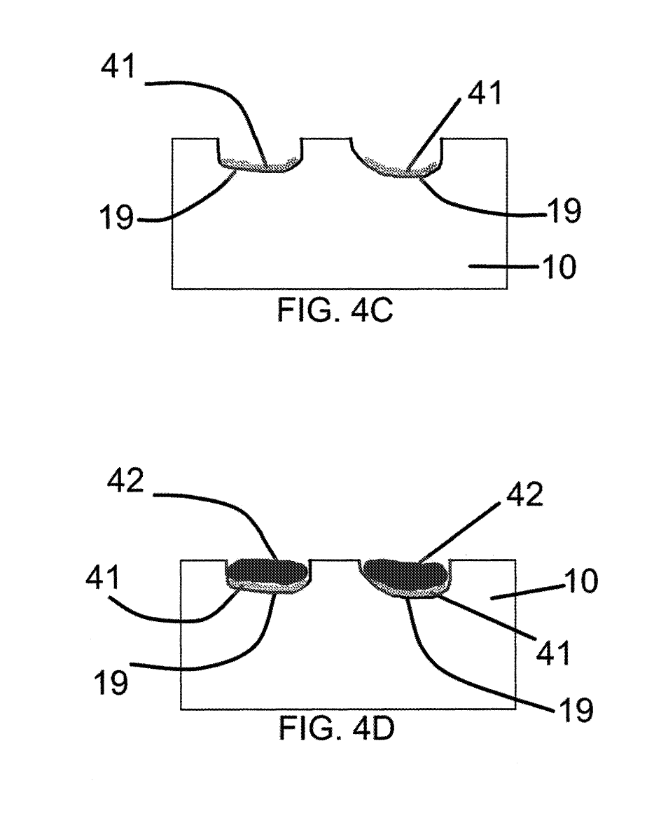

With regard to FIG. 4A to 4D, we can see partial cross section of a plurality of lines (with showing of just 2 parallel lines). In FIGS. 4A and 4B, a method for printing over a flat surface is shown and in FIGS. 4C and 4D, a method for printing inside cavities is shown.

Referring now to FIGS. 4A through 4D, a plurality of parallel lines are created and are normal to the surface of drawing (x and y axes is shown in this figure and z-axis that is normal to the xy plane will be the direction of parallel lines of conductors). We can print this thin conducting film 41 over a flat surface or inside predefined cavities. As a result of printing and curing ink, plural lines of thin conducting film will be created and after this step, we have couple of options to create thick conductors 42.

1. Thick film will be deposited over thin conducting film by electrodeposition method. (An optional resistive layer might be added over thin conducting film and before electrodeposition if needed.)

2. Electroless deposition method can also be used to deposit thick film conductor. In this case, thin conducting film will act as catalyst to provide growth site for electrodeposited metal.

### Embodiment CC

In yet another embodiment, direct printing of catalyst seed is another additive manufacturing method similar to the embodiment C discussed above. In this case, we print predefined patterns of catalyst seeds instead of thin conductive ink. After that, we move the substrate to an electroless deposition bath to create plural thin films over these catalyst patterns. We can give this electroless deposition reaction more time to create thick film directly, or we can move this substrate to another electroless deposition bath to create different thick film over it or we can opt for electrodeposition to create thick film. In the case of electrodeposition, we can use optional resistive layer as mentioned before.

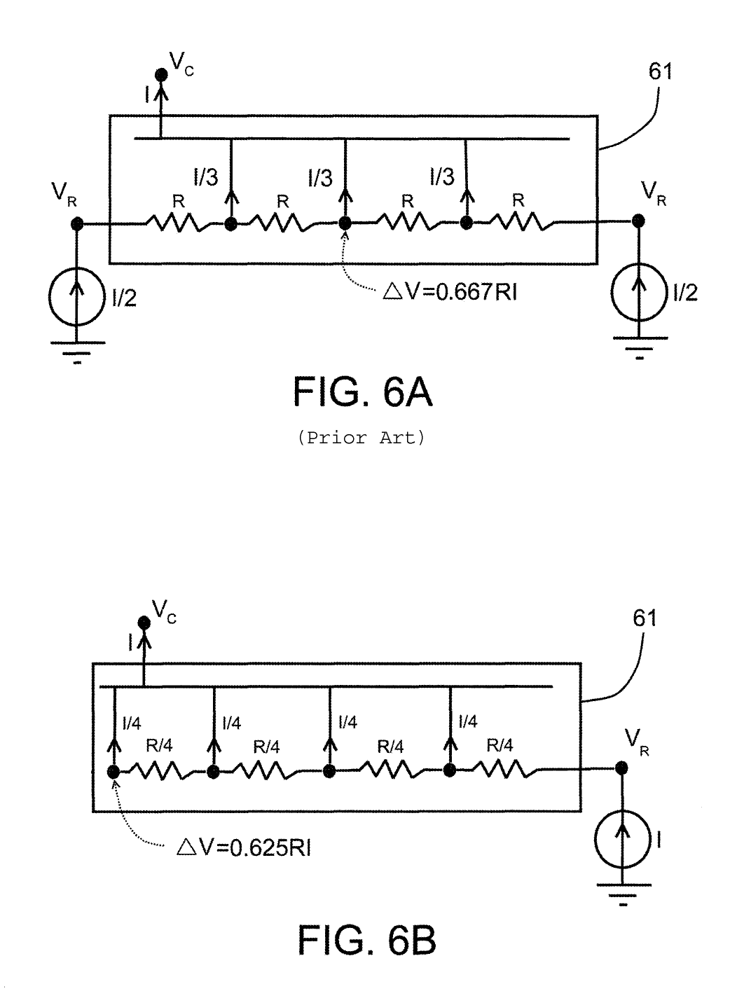

It was mentioned at the beginning of this application that this invention can lead to increased performance of displays, especially high current displays like SED and BSD. In order to give an example, with reference to FIG. 6A and 6B, V_{R} is voltage of row driver, V_{C} is voltage of column drivers, I is total current of device and 61 is used to show an encapsulated display with only one row line and just couple of columns.

With reference to FIG. 6A and 6B; we compare these two designs. It is assumed that in a SED manufactured according to this invention, resistance of row lines are reduced by a quarter of the original value. This amount of resistance reduction is completely achievable and even more reduction is feasible because thickness of row conductors can be increased substantially with ease. As one can see in FIG. 6A (prior art) the worst place of row line in terms of voltage drop when compared to the ends of row lines is the middle of the row line. Assuming that two ends of row lines are being held in a similar voltage (V_{R}), voltage difference between the middle of row line and the ends of it equals to 0.667RI. In the second design FIG. 6B, the worst voltage drop will occur at the end that is furthest away from the row driver. At that point, we see the voltage difference from row driver node equals to 0.625RI. So in latter design 2, the voltage drop is less than the prior art. Additionally, if we opt for lower resistance row lines, we can further decrease voltage difference between different parts of row conductor while in the same time reduce both driver cost and manufacturing cost of display.

Although the instant invention has been described in relation to particular embodiments thereof, many other variations and modifications and other uses will become apparent to those skilled in the art.

What is claimed is:

1. A method of manufacturing a plurality of thick conducting lines for display devices by means of plating method whereby low resistivity and low manufacturing cost are realized comprising the steps of:
preparing a substrate for surface treatments;
coating said substrate with a thin conducting film;
applying a thick metal film over said thin conducting film by means of plating method whereby a thick layer is created; and
removing selected portion of said thick metal film and said thin conducting film whereby a plurality of thick conducting lines are created.

2. The method of manufacturing a plurality of thick conducting lines for display devices according to claim 1 wherein the step of preparing a substrate for surface treatments further comprises the step of coating said substrate with catalytic seeds whereby a more suitable surface for electroless deposition is created.

3. The method of manufacturing a plurality of thick conducting lines for display devices according to claim 1 wherein the step of preparing a substrate for surface treatments further comprises the step of creating a plurality of predefined grooves therein.

4. The method of manufacturing a plurality of thick conducting lines for display devices according to claim 3 wherein the step of removing selected portion of said thick metal film and said thin conducting film further comprises the step of planarizing said substrate using a CMP method whereby a plurality of thick conducting lines that are buried inside said grooves are created.

5. The method of manufacturing a plurality of thick conducting lines for display devices according to claim 1 wherein the step of applying a thick metal film over said thin conducting film by means of plating method further comprises the step of using electroless plating method to apply said thick metal film.

6. The method of manufacturing a plurality of thick conducting lines for display devices according to claim 1 wherein the step of applying a thick metal film over said thin conducting film by means of plating method further comprises the step of using electroplating method to apply said thick metal film.

7. The method of manufacturing a plurality of thick conducting lines for display devices according to claim 6 further comprising step of applying a resistive layer between said thin conducting film and said thick metal film wherein homogeneity of said thick metal film is increased.

8. The method of manufacturing a plurality of thick conducting lines for display devices according to claim 6 wherein the step of applying a thick metal film further comprises adding a physical barrier over said substrate inside a plating bath whereby homogeneity of said thick metal film is increased.

9. The method of manufacturing a plurality of thick conducting lines for display devices according to claim 1 wherein the step of removing selected portion of said thick metal film and said thin conducting film further comprises steps of:
applying a patterned mask over said thick metal film;
removing material from an unprotected portion of said thick metal film and said thin conducting film whereby grooves are created; and
removing said patterned mask whereby metal lines are defined therein.

10. A method of manufacturing a plurality of thick conducting lines for display devices by means of electroless plating method whereby low resistivity and low manufacturing cost are realized comprising the steps of:
preparing a substrate for surface treatments;
coating said substrate with catalytic seeds;
applying a thick metal film over said catalytic seeds by means of electroless plating method whereby a thick layer is created; and
removing a selected portion of said thick metal film whereby a plurality of thick conducting lines are created.

11. The method of manufacturing a plurality of thick conducting lines for display devices according to claim 10 wherein the step of preparing a substrate for surface treatments further comprises the step of creating a plurality of predefined grooves therein.

12. The method of manufacturing a plurality of thick conducting lines for display devices according to claim 11 wherein the step of removing said selected portion of said thick metal film whereby a plurality of thick conducting lines are created further comprises the step of planarizing said substrate using a CMP method whereby a plurality of thick conducting lines that are buried inside said grooves are created.

13. The method of manufacturing a plurality of thick conducting lines for display devices according to claim 10 wherein the step of removing said selected portion of said thick metal film whereby a plurality of thick conducting lines are created further comprises steps of:
applying a patterned mask over said thick metal film;
removing material from an unprotected portion of said thick metal film whereby grooves are created; and
removing said patterned mask whereby metal lines are defined therein.

14. A method of manufacturing a plurality of thick conducting lines for display devices by means of plating method whereby low resistivity and low manufacturing cost are realized comprising the steps of:
preparing a substrate for surface treatments;
coating said substrate with a plurality of thin conducting lines; and
applying thick metal coating over said thin conducting lines by means of plating method whereby a plurality of thick metal lines are created.

15. The method of manufacturing a plurality of thick conducting lines for display devices according to claim 14 wherein the step of coating said substrate with a plurality of thin conducting lines further comprises steps of:
directly printing a plurality of thin precursor lines; and
converting a plurality of said thin precursor lines to thin conducting lines.

16. The method of manufacturing a plurality of thick conducting lines for display devices according to claim 14 wherein the step of preparing a substrate for surface treatments further comprises the step of creating a plurality of predefined grooves therein.

17. The method of manufacturing a plurality of thick conducting lines for display devices according to claim 16 wherein the step of coating said substrate with a plurality of thin conducting lines further comprises steps of:
applying a thin metal film over entire area of said substrate; and
using a CMP method that removes portions of said thin metal film that is applied over topmost planar area of said substrate but leaves portions of said thin metal film that is applied over the surface of said predefined grooves whereby a plurality of thin conducting lines inside said predefined grooves are created.

18. The method of manufacturing a plurality of thick conducting lines for display devices according to claim 14 wherein the step of applying thick metal coating over said thin conducting lines by means of plating method further comprises the step of using an electroless plating method to apply said thick metal coating.

19. The method of manufacturing a plurality of thick conducting lines for display devices according to claim 14 wherein the step of applying thick metal coating over said thin conducting lines by means of said plating method further comprises the step of using electroplating to apply said thick metal coating.

20. The method of manufacturing a plurality of thick conducting lines for display devices according to claim 19 further comprising step of applying a resistive layer between said thin conducting lines and said thick metal coating wherein homogeneity of said thick metal film is increased.

21. The method of manufacturing a plurality of thick conducting lines for display devices according to claim 19 wherein the step of applying a thick metal film further comprises adding a physical barrier over said substrate inside a plating bath wherein homogeneity of said thick metal film is increased.
